(19) United States
(12) Patent Application Publication
(10) Pub. No.: US 2026/0250577 A1
(43) Pub. Date: Aug. 27, 2026

(54) Emulsion Polymerized Emulsions from Polydimethyl Siloxane Mixture and Consequence of Cyclic Generation in Final Emulsion

(71) Applicant: Wacker Metroark Chemicals Pvt. Ltd., West Bengal (IN)

(72) Inventor: Amit Kumar Paul, Kolkata (IN)

(21) Appl. No.: 18/577,565

(22) PCT Filed: Jul. 9, 2022
(86) PCT No.: PCT/IB2022/056360

§ 371 Date: Jan. 8, 2024

(30) Foreign Application Priority Data
Jul. 9, 2021 (IN) 202131030925

(51) Int. Cl. C09K 23/12; B01F 23/41

(52) U.S. Cl. CPC C09K 23/12; B01F 23/4105

(57) ABSTRACT

Present invention describes a commercial manufacturing process of a stable emulsion having particle size (D50 value) up to 1000 nanometer and up to 3000 ppm of cyclosiloxane(s) comprises providing a formulation comprising a mixture of two or more organopolysiloxane first emulsifying using a mixture of non-ionic and neutralized anionic emulsifier and undergoing emulsion polymerization below 12° C. by a non-neutralized anionic emulsifier and then neutralizing the emulsion by alkali to a pH range 6-8.

### BACKGROUND OF THE INVENTION

The need of an emulsion polymerized (EP) emulsion is increasing day by day and replacing the use of silicone fluid in the personal or home care formulation by such emulsion. This is because, an emulsion always needs less silicone or siloxane fluid in the composition, for the desired effect than directly using the liquid silicone or siloxane (called silicone fluid) in the cosmetic formulation. Moreover, handling emulsions are easier and could be directly added to the final product composition. Also, such emulsion shows enhanced benefits in respect of both conditioning, slippery feel/smoothness/detangling hair due to silicone deposition as they are dispersed in form of small stabilized silicone or siloxane particles and thus have this enhanced or increased surface area for proper and sufficient exposure at the contact area on hair.

In the emulsion polymerization reaction of cyclosiloxane or small chain siloxane molecules, there are many prior arts suggesting about the method of preparation and optimization of the reaction conditions for obtaining emulsion polymerized (EP) emulsion with higher siloxane polymer viscosities.

Thus, we understand that smaller the emulsion particle, higher is their surface area and usually higher will be the desired effect in terms of conditioning or softness or smoothness or any other properties. Again, it is also known that for an emulsion, higher the viscosity of the dispersed fluid, higher is the conditioning characteristics. This high viscous silicone oil emulsion having lower particle size is difficult to make by homogenizing high viscous silicone oil. To overcome the problem of making high viscous low particle silicone emulsion, there are very well known technology already established and many patent applications are published on the technology which is called the emulsion polymerization (EP) technique. In emulsion polymerization technique, silicone cyclics or short chain silicone polymer is emulsified easily with surfactant and can achieve lower particle size according to desire particle size. After emulsification, add the polymerization catalyst or used certain type of emulsifiers (cationic or anionic) that help for making stable emulsion and also act as polymerization catalyst to allow silicone in emulsion to polymerize and neutralize the catalyst when silicone in polymer reach to desire polymer chain length.

Generally, all silicone emulsion made by emulsion polymerization technique contain higher amount silicone cyclics. Globally, many countries are carrying out safety studies on silicone cyclics and according to the published study reports the findings are of mixed concerned. Considering the inconclusive safety data of silicone cyclics, the knowledge available about the emulsion polymerization techniques for reducing silicone cyclics in final emulsion is limited and such techniques are difficult to use in industry. Due to the backbiting reaction, the generation of the cyclics in the emulsion is normal and the industry is actively working on reducing such cyclosiloxane in the final products. Thus, there are different processes and methods that are currently developed to reduce the cyclosiloxane to a certain level, so that the final product has reduced cyclosiloxane<3000 ppm and preferable <2000 ppm.

Thus, there is a need of such chemistry that will help to achieve the desired (low) cyclosiloxane concentration in final emulsion while being cost effective, time efficient, easy to achieve and scaleup, and yields less cyclosiloxane.

The production of EP emulsion by the cyclosiloxane as the starting material needs higher initial temperature and the EP emulsion by —OH— terminated siloxane requires lower starting temperature to start polymerization.

There are many prior arts that direct the preparation method to optimize such formation of EP emulsion by OH terminated siloxane:

U.S. Pat. No. 9,156,954B2 relates to a method to produce silicone in water emulsions by emulsion polymerization. The emulsion contains particles of an organopolysiloxane polymer having an average particle diameter of less than 1 μm. The method comprises: combining a silanol end-blocked organosiloxane starting polymer, water, and a surfactant; said starting polymer having a viscosity of at least 2000 mPa·s to 150000 mPa·s; emulsifying the starting polymer by agitating or shearing the ingredients; polymerizing the starting polymer to form a longer chain silanol end-blocked organopolysiloxane polymer; wherein at least a portion of said polymerizing step is performed at a temperature of less than or equal to 16° C. preferably less than or equal to 15° C. Here, the siloxane starting polymer, the surfactant and the water are fed into a high shear mixer through a single supply line and the pressure in the supply line at the inlet to the high shear mixer. Thus, this process is economically not viable and need high pressure mechanism for the process.

U.S. Pat. No. 9,765,189B2 relates to an organopolysiloxane emulsion composition having good age stability is prepared by (I) emulsifying a mixture comprising (A) an organopolysiloxane of formula: HO(R1 2SiO) nH, has a kinematic viscosity of 200 mm²/s to less than 2,000 mm²/s at 25° C. (B) a surfactant and (C-1) water to form a first emulsion composition and (II) effecting emulsion polymerization of the first emulsion composition in the presence of (D) an acid catalyst below 40° C. The target emulsion composition contains an organopolysiloxane product having a viscosity≥300,000 mPa·s at 25° C. and an octamethylcyclotetrasiloxane content≤3,000 ppm and has an emulsified particle size≤500 nm. Here, lower viscosity OH polymer is used primarily for the intent that the method will requires a large amount of surfactant in order to prepare an emulsion of submicron particles.

U.S. Pat. No. 9,895,296 relates to organopolysiloxane with terminal silanol groups, having a viscosity of 5,000 mm²/s is emulsified by the mixture of non-ionic emulsifier and dodecylbenzene sodium sulfonate (which is neutralized and thus do not act as a catalyst for the polymerization reaction) that acts as an anionic emulsifier. The emulsion formed is then reduced to 0° C. and then 1.2 parts by mass of the hydrochloric acid is added to reduce the pH of the reaction, which then initiate the polymerization reaction. Such addition of acid may sometimes destabilize the emulsion and in the middle of the reaction may change the particle size of the emulsion and will affect the rate of emulsion polymerization reaction, and my lead to higher cyclic siloxane in the final emulsion. Also, when an organopolysiloxane with terminal silanol groups, having a viscosity of 5,000 mm²/s is emulsified, the emulsification needs high shear and high-pressure costly devices to form the emulsion and thus it is difficult to maintain the cost of the final product and thus a different solution is required so that the final requirement is met in a cost-effective manner. Here, they are using acid catalyst, at a temperature of −15 to 5° C. They are using a very low temperature and viscosity of the material is so high that the rate of polymerization will be very low. Such process of forming emulsion will affect in final properties of the emulsion and thus is not desirable.

EP1072629 B1 discloses an emulsion process, for which linear alkyl benzene sulfonic acid, non-ionic surfactant such as alkyl alcohol ethoxylate are taken and alpha omega hydroxy terminated polydimethyl siloxane of low viscosity is mixed in a reactor and during such reaction the reaction temperature is kept below 40° C. preferably below 30° C. Though it discloses a step of first emulsification and then reduction of temperature for increase in rate of polymerization, such process does happen as the LABSA and the non-ionic surfactant helps to simultaneously form emulsion during the mixing step. By using such low viscosity alpha omega hydroxy terminated polydimethyl siloxane the final required cyclic concentration of below 3000 ppm is not achieved and thus such low viscosity starting polymer do not lead to the desired result.

In U.S. Pat. No. 8,475,777B2, the emulsions of high viscosity silicones are prepared by emulsifying a lower viscosity condensable silicone with a partial phosphate ester surfactant and ripening the emulsion to obtain a higher viscosity silicone dispersed phase without of generation objectional amounts of octaorganocyclotetrasiloxanes. The emulsions are well suited for personal care products. But such new phosphate ester surfactant need stringent testing protocols and since animal testing has stopped in many countries hence very few new ingredients are readily accepted as personal care additives.

In all the above prior arts, '189 patent discloses that the emulsion polymerization step (II) of the first emulsion composition be performed at a temperature of lower than 40° C. for a time within 48 hours, temperature more preferably below 15° C., if the polymerization time exceeds 48 hours, there is a risk that more D4 by-product forms. Thus, the polymerization time is preferably 1 to 40 hours, more preferably 5 to 30 hours.

In '296 the emulsion formed is reduced to 0° C. and hydrochloric acid is added to reduce the pH and to initiate the polymerization reaction. Here, the temperature as mentioned in the patent is very low to hinder the workability of the intermediate mixture before formation of the emulsion also. Hence, the prior arts do not provide a practical working solution as required to fulfill the desired EP reaction.

Thus, there is a need of new method or process of emulsion polymerization method, so that the drawbacks of the prior art are overcome.

### OBJECT OF THE INVENTION

It is an object of the present invention to provide a novel method or process of emulsion polymerization which overcomes the drawbacks of the prior art.

It is an object of the present invention to provide a novel method or process of emulsion polymerization which is time and cost effective, easy to achieve and scale, and yields less cyclosiloxane.

It is an object of the present invention to provide a novel method or process of emulsion polymerization wherein the method reduces the cyclosiloxane to a certain level, so that the final product has reduced cyclosiloxane<3000 ppm and preferably <2000 ppm.

### SUMMARY OF INVENTION

In one aspect the present invention provides a commercial manufacturing process of a stable emulsion having particle size (D50 value) of upto 1000 nanometer and cyclosiloxane content of upto 3000 ppm comprising:
i) providing a formulation comprising
   (a) a starting organopolysiloxane comprising one or more organopolysiloxane of general formula (I) or its mixture

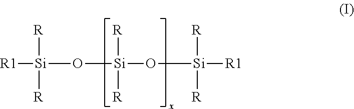

where R¹ is same or different and is a monovalent hydrocarbon group of 1 to 10 carbon atoms or a hydroxyl group or an alkoxy group having 1 to 8 carbon atoms,
R is same or different and is a monovalent hydrocarbon radical,
x is same or different and is an integer from 1 to 2000,
(b) water,
(c) a non-ionic emulsifier(s) having HLB in the range of 8-19 and
(d) a neutralized anionic emulsifier;
ii) homogenizing the formulation using any standard homogenizer and maintaining a temperature up to 35° C.;
iii) cooling the formulation below a temperature of 12° C.;
iv) adding an anionic emulsifier to obtain an organopolysiloxane polymer with viscosity of at least 20000 mPa·s at 25° C.; and
iii) neutralizing the emulsion by alkali to a pH range of 6 to 8.

### DESCRIPTION OF THE INVENTION

Described herein is a commercial manufacturing process of a stable emulsion having particle size (D50 value) up to 1000 nanometer and upto 3000 ppm of cyclosiloxane(s) comprising:
i) providing a formulation comprising (a) 20 to 80% by weight of starting organopolysiloxane comprising one or more organopolysiloxane of general formula (I) or its mixture

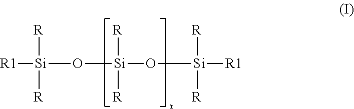

where R¹ is same or different and is a monovalent hydrocarbon group of 1 to 10 carbon atoms or a hydroxyl group or an alkoxy group having 1 to 8 carbon atoms,
R is same or different and is a monovalent hydrocarbon radical,
x is same or different and is an integer from 1 to 2000,
(b) water in an amount of 5 to 50% by weight,
(c) non-ionic emulsifier(s) having HLB in the range of 10-19 in amounts of 1 to 25% by wt. and
(d) an alkanolamine neutralized anionic emulsifier selected from organic sulfonic acids having HLB in the range of 8-19 in an amount of 1 to 10% by weight;
ii) homogenizing the mix of (i) using any standard homogenizer and maintaining a temperature upto 35° C.;
iii) cooling the mix of (i) and after reaching a temperature below 12° C.;
iv) adding an anionic emulsifier selected from organic sulfonic acids having HLB in the range of 8-19 in an amount of 1 to 15% by. wt. such as to obtain an organopolysiloxane polymer with viscosity of at least 20000 mPa·s; and
iii) neutralizing the emulsion by alkali to a pH range 6-8.

In one of the specific embodiments, the process where the starting polyorganosiloxane is a mixture of two or more polyorganosiloxane of general formula I.

Thus, it is found that by applying the commercial manufacturing process the desired final product specification is also achieved.

In one of the embodiments, the neutralized anionic emulsifier is an alkanolamine neutralized salt of acid selected from alkyl aryl sulfonic acid, alkyl sulfonic acid, aryl sulfonic acid, optionally a dialkyl or diaryl sulfonic acid or its mixture thereof.

The present invention is the process of emulsion polymerization of mixture of different viscosities OH polymers or OH polymer (below 50000 mPa·s at 25° C.) and trimethylsiloxy terminated siloxane below 50000 mPa·s at 25° C.) or trimethylsilanol or mixture of OH polymer (below 50000 mPa·s at 25° C.) and trimethylsiloxy terminated siloxane below 50000 mPa·s at 25° C.) or trimethylsilanol, where mixture of OH polyemrs having viscosity of below 50000 mPa·s at 25° C. or OH polymer (below 50000 mPa·s at 25° C.) and trimethylsiloxy terminated siloxane below 50000 mPa·s at 25° C.) or trimethylsilanol or mixture of OH-terminated siloxane (below 50000 mPa·s at 25° C.) and trimethylsiloxy terminated siloxane below 50000 mPa·s at 25° C. or trimethylsilanol along with emulsifiers are cooled to 7-15° C. The emulsifiers comprising a neutralized anionic emulsifier (preferably neutralized LABSA which is at least 5% of the total LABSA concentration) and at least one non-ionic emulsifier having final HLB value in the range of 8-20, added followed by rest surfactant & water, all raw materials are cooled to 7-15° C. for better cream formation.

In prior art, all the anionic surfactant is neutralized, and the neutral anionic surfactant is used in the initial process of emulsification at a relatively higher temperature, and then to start the polymerization the temperature is reduced, and an acid catalyst is used to initiate polymerization reaction. Such process needs extreme control of the pH value as one of the reaction conditions and even a slight lowering of pH may start the polymerization process during emulsification, and thus the criteria of reduction of cyclic will not meet for such process. In prior art, there is no focus on temperature control during emulsification can destabilize the neutral salt and anionic surfactant starts polymerization in parallel with cyclic generation due to back biting reaction.

In the present invention, the problem of high cyclics in the final emulsion composition is solved by first reducing the temperature of the ingredients from 7-15° C. and using mixed silicone with a part of the neutralized anionic emulsifier and mixing it with at least one non-ionic emulsifier, from the beginning of the reaction, and using such mixed emulsifier to emulsify the alpha omega mixtures of OH polymers having viscosity of below 50000 mPa·s at 25° C. or OH polymer (below 50000 mPa·s at 25° C.) and trimethylsiloxy terminated siloxane below 50000 mPa·s at 25° C.) or trimethylsilanol or mixture of OH-terminated siloxane (below 50000 mPa·s at 25° C.) and trimethylsiloxy terminated siloxane below 50000 mPa·s at 25° C.) or trimethylsilanol, in one of the embodiments mixtures of OH polymers or OH-terminated siloxane and trimethylsiloxy terminated siloxane or trimethylsilanol or mixture of OH-terminated siloxane and trimethylsiloxy terminated siloxane or trimethylsilanol groups) reveals the surprising facts where the polymerization reaction do not starts from the beginning & emulsion temperature is also possible to control below 30° C. during the emulsification process & emulsion cream viscosity is possible to maintain within control limit due to mixed silicone emulsification that makes the process more industry favorable commercial process. Due to such initiation of the emulsion formation at the beginning of the reaction by utilizing appropriate emulsifier concentration, and not initiating the polymerization reaction the cyclic formation could be restricted in the final composition, and after complete emulsification as the fluid (siloxane) are now restricted in the droplet of an emulsion, thus are not freely available for back-biting mechanism and thus increase in cyclic formation in the final composition is restricted. Also, as at the later stage during polymerization since the remaining anionic emulsifier is used as a catalyst and since additional separate hydrochloric acid or sulfuric acid is not added in the system, there are further less chances of breaking the stable emulsion formed and thus further benefiting the final composition with desired least cyclic formation. Making emulsion in a neutralized condition and with a certain lower temperature for making the desired particle size emulsion do not increases above 40° C., so that neutralized salt become unstable and there after completion of emulsification, the material temperature is dropped to 10° C. and above 5° C. and catalyst is used. Reaction rate and viscosity is not too high.

In a separate container, 25-50 parts from 100 parts linear alkyl benzene sulfonic acid (LABSA) is taken and neutralized to form neutralized LABSA, and 50-75 parts is kept aside for later use.

The 25-50 parts of neutralized LABSA is then cooled to 12° C. and added to the reactor along with the mixtures of OH polymers having viscosity of below 50000 mPa·s at 25° C. or OH polymer (below 50000 mPa·s at 25° C.) and trimethylsiloxy terminated siloxane below 50000 mPa·s at 25° C.) or trimethylsilanol or mixture OH-terminated siloxane (below 50000 mPa·s at 25° C.) and trimethylsiloxy terminated siloxane (below 50000 mPa·s at 25° C.) or trimethylsilanol) and other ingredients (non-ionic emulsifier) along with followed by mixing and starting the homogenizing process. The homogenized composition is then transferred to a cooling tank where the temperature reduces to 8° C., then 50-75 parts of non-neutralized LABSA is added and kept for polymer viscosity that grow to more than 0.1 Mio mPa·s in less than 25 hours.

Thus, according to a basic aspect of the present invention, it is provided a commercially possible production process for the manufacture of a stable emulsion comprising:
i) providing a formulation comprising
   (a) a starting organopolysiloxane comprising one or more organopolysiloxane of general formula (I) or its mixture

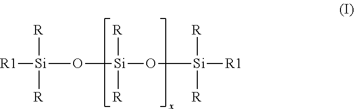

where R¹ is same or different and is a monovalent hydrocarbon group of 1 to 10 carbon atoms or a hydroxyl group or an alkoxy group having 1 to 8 carbon atoms,
R is same or different and is a monovalent hydrocarbon radical,
x is same or different and is an integer from 1 to 2000,
(b) water,
(c) a non-ionic emulsifier(s) having HLB in the range of 8-19 and
(d) a neutralized anionic emulsifier;
ii) homogenizing the formulation using any standard homogenizer and maintaining a temperature up to 35° C.;
iii) cooling the formulation below a temperature of 12° C.;
iv) adding an anionic emulsifier to obtain an organopolysiloxane polymer with viscosity of at least 20000 mPa·s at 25° C.; and
iii) neutralizing the emulsion by alkali to a pH range of 6 to 8.

Importantly, it is found by way of the invention that one of the critical aspects which enable obtaining an emulsion of required particle size by a simple process is the selective use of a combination of non-ionic emulsifier together with at least one neutralized anionic emulsifier to achieve the desired particle size emulsion. During the polymerization step of the EP, the temperature is usually kept below 16° C. and preferably greater than 5° C.; in one of the other embodiments the temperature during polymerization step is between 5° C. and 16° C., this is because below 5° C. the workability of the total composition is not good, and higher torque hence, higher energy and time is required to continue the process. For organopolysiloxane (silicone) emulsions, an HLB value of the emulsifier mixture near the range of 9-16 is found to be the optimum value of the emulsifier or a mixture of emulsifiers, which help to make small particle emulsions. It is also found that a mixture of non-ionic and neutralized anionic emulsifiers having an HLB value near the range of 12-15 is optimum for making small particle size, stable emulsions with a standard homogenizer.

Also, the quantity of the emulsifiers used in the above selective formulation have selective contribution to make the emulsion stable. The above process of making small particle organopolysiloxane emulsions, the emulsion is also stabilized by use of surfactants having critical HLB values that help to make faster small particle emulsions by using a standard homogenizer without need for a complex ultra-high-pressure homogenizer.

Moreover, it is also important to control the temperature for achieving small particle sizes with narrow particle size distribution.

Lower temperature during the emulsion preparation is found to have great importance, not only to control the particle size, but also to control the particle size distribution and also restrict the destabilization of neutral anionic surfactant. In the above process of the invention, preferably, a suitable biocide is added for preventing microbial growth.

Since, the process uses a mixture of surfactants for making small particle size organopolysiloxane emulsions by using standard homogenizers, it is important to maintain the selective formulation involving making a proper quantity of surfactants and proportion of organopolisiloxanes and surfactants to achieve required particle sizes.

In accordance with a preferred aspect of the above process for the manufacture and faster production of stable small particle-size emulsions having high internal phase oil viscosity, the method comprises:
(i) Load mixtures of OH polymers having viscosity of below 50000 mPa·s at 25° C. or OH polymer (below 50000 mPa·s at 25° C.) and trimethylsiloxy terminated siloxane below 50000 mPa·s at 25° C.) or trimethylsilanol or mixture of OH-terminated siloxane (below 50000 mPa·s at 25° C.) and trimethylsiloxy terminated siloxane below 50000 mPa·s at 25° C.) or trimethylsilanol) in the reactor & cooled below 30° C., providing a selective formulation comprising water in an amount of 5 to 30% of the emulsion, 8 to 30% mixed emulsifiers comprising at least one neutralized anionic emulsifier (preferably neutralized LABSA) and at least one non-ionic emulsifier having an HLB value in the range of 10-19, and an organopolysiloxane or mixture of organopolysiloxanes in the range of 20-80% of the emulsion.
a selective formulation comprising water in an amount of 1 to 50% of the emulsion, 1 to 30% mixed emulsifiers comprising a neutralized anionic emulsifier (preferably neutralized LABSA which is 25-50% of the total LABSA concentration) and at least one non-ionic emulsifier having an HLB value in the range of 10-19, added followed by rest surfactant & water, all raw materials are cooled to 12° C. for better cream formation,
(ii) homogenizing the mixture with a standard homogenizer while maintaining a temperature in a range below 40° C., preferably in the range of 7-25° C., for a time period of not more than five hours depending on the desired characteristics of the emulsion;
(iii) allowing the emulsion to age in the range of 7-20° C. to facilitate faster increase in the viscosity of the internal phase oil; Transfer to cooling tank, when temperature reaches 7-20° C., add rest 50-75% LABSA to the emulsion, kept for polymer growth & viscosity reached more than 0.1 Mio mPa·s at 25° C. within 25 hours;
(iv) neutralizing the emulsion with alkali and finally, optionally adding biocide for microbial prevention in the emulsion.

The temperature of the material can be controlled during homogenizing by cooling with water. In the above process, the desired aging temperature for growth of very high internal oil viscosity is in the range of 5 to 30° C. Generally, 1 to 12 hours is required to achieve a very high internal phase oil. If internal oil viscosity is needed to be less than 500,000 mPa·s at 25° C., then neutralizing of the emulsion is carried out immediately after completion of LABSA mixing. Moreover, it is found that desired mixing time also varies for target viscosity of the polymer and distribution of the particles in the emulsion.

The emulsion is neutralized after completion of dilution steps. Generally, water-soluble inorganic alkali hydroxide or organic alkanolamine is used for neutralization. Preferably, sodium hydroxide or potassium hydroxide or triethanolamine or other amines are used to neutralize the emulsion. The neutralizing agent is an alkanolamine of the formula: (R″OH) 3N, whereas R″ is an alkyl group and preferably methyl or ethyl.

According to the present invention, one of the critical parameters includes the selection of the right emulsifiers and combination of the emulsifiers to achieve the desired small particle size emulsion. The present invention thus achieves producing small particle emulsions in a simple way where selective emulsifier combinations and the temperature of emulsification and polymerization play a critical role in making the process simple and avoiding the use of expensive and complex machinery.

The invention thus provides a process for making stable small particle emulsion from a mixture of organopolysiloxanes. Organopolysiloxanes referred to herein for the invention include alpha omega-mixtures of OH polymers or mixture of OH-terminated siloxane and trimethylsiloxy terminated siloxane or trimethylsilanol or mixture of OH-terminated siloxane and trimethylsiloxy terminated siloxane or trimethylsilanol; alpha, omega-alkoxy terminated organopolysiloxanes; organocyclopolysiloxanes; or a mixture thereof.

In the case of branched polysiloxane emulsions a tri-functional or tetra-functional silane or a mixture thereof is used together with above organopolysiloxanes.

The viscosity of the fluids, its mixture and the emulsion prepared by the fluid is measured at 25° C. by Anton Paar Rheometer; model MCR101, geometry single gap cylinder: CC27 spindle and shear rate 1 s⁻¹ for 2 minutes at 25° C. is used for viscosity between 1 to 15,000 mPa·s at 25° C. (Mio is million i.e. 10⁸). Anton Paar Rheometer; model MCR101, 25-6 cone (Cone-plate geometry: 25 mm dia./6° cone) and the “Zero gap” setting is made and shear rate 1 s⁻¹ for 2 minutes at 25° C., is used for viscosity between 15,000 to 10,00,000 mPa·s at 25° C. Three measurements are made for each sample and the viscosity value is taken at 60 secs. MCR Rheometer Series products works as per USP (US Pharmacopeial Convention) 912-Rotational Rheometer methods.

In one of the embodiments, the pH is determined by the pH meter or by using indicator-based technology e.g. litmus paper or pH paper.

The alpha, omega-functional end blocked linear organopolysiloxanes used herein are preferably those of the general formula I:

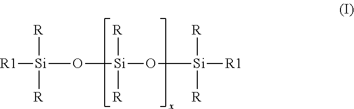

Where R1 is hydrogen and/or a monovalent hydrocarbon group of 1 to 10 carbon atoms and/or a hydroxyl group and/or an alkoxy group having 1 to 8 carbon atoms. Examples of R1 as a monovalent hydrocarbon group are methyl, ethyl, n-propyl, isopropyl, n-butyl, isobutyl, tert-butyl, n-pentyl, isopentyl, neopentyl, tertpentyl, hexyl such as n-hexyl, heptyl such as n-heptyl, octyl such as n-octyl and isooctyl such as 2,2,4-trimethyl-pentyl, nonyl such as n-nonyl, decyl such as n-decyl, dodecyl such as n-dodecyl, octadecyl such as n-octadecyl; alkenyl such as vinyl and allyl; cycloalkyl such as cyclopentyl, cyclohexyl, cycloheptyl and methyl cyclohexyl; aryl such as phenyl, naphthyl, anthryl and phenanthryl; alkylaryl such as o-, m-, p-tolyl, xylyl and ethylphenyl; such as benzyl, and α- and β-phenylethyl; of which methyl, ethyl, n-propyl, and isopropyl are preferred, and methyl is particularly preferred. Examples of R¹ as an alkoxy group are methoxy, ethoxy, propoxy, butoxy, pentoxy, hexoxy or phenoxy, but are not limited to these groups.

Where R, which may differ, is a monovalent hydrocarbon radical. Examples of R are alkyl radicals such as methyl, ethyl, n-propyl, isopropyl, n-butyl, isobutyl, tertbutyl, n-pentyl, isopentyl, neopentyl, tertpentyl, hexyl such as n-hexyl, heptyl, such as n-heptyl, octyl such as n-octyl and isooctyl such as 2,2,4-trimethylpentyl, nonyl such as n-nonyl, decyl such as n-decyl, dodecyl such as n-dodecyl, octadecyl such as n-octadecyl; alkenyl such as vinyl and allyl; cycloalkyl such as cyclopentyl, cyclohexyl, cycloheptyl and methyl cyclohexyl; aryl such as phenyl, naphthyl, anthryl and phenanthryl; alkylaryl such as o-, m-, p-tolyl, xylyl and ethylphenyl; aralkyl, such as benzyl, and α- and β-phenylethyl; of which methyl, ethyl, n-propyl, and isopropyl are preferred, and methyl is particularly preferred.

x is same or different and is an integer from 1 to 2000.

The cyclosiloxanes described here is an organocyclosiloxanes selected from one or more octamethylcyclotetrasiloxane; decamethylcyclo-pentasiloxane; dodecamethyl cyclohexasiloxane.

Organopolysiloxanes used according to the present invention may be branched by way of incorporation of branching units. Branching units may be introduced to improve the film forming behavior of organopolysiloxane. Branching units may comprise a trifunctional silane or tetrafunctional silane or a mixture thereof. Trifunctional silanes (III) and tetrafunctional silanes (IV) have the following structure:

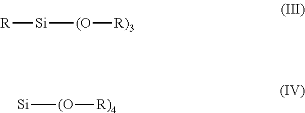

Where R, which may differ, is a monovalent hydrocarbon radical. Examples of R are alkyl radicals such as methyl, ethyl, n-propyl, isopropyl, n-butyl, isobutyl, tert-butyl, n-pentyl, isopentyl, neopentyl, tert-pentyl, hexyl such as n-hexyl, heptyl such as n-heptyl, octyl such as n-octyl and isooctyl such as 2,2,4-trimethylpentyl, nonyl such as n-nonyl, decyl such as n-decyl, dodecyl such as n-dodecyl, octadecyl such as n-octadecyl; alkenyl such as vinyl and allyl; cycloalkyl such as cyclopentyl, cyclohexyl, cycloheptyl and methyl cyclohexyl; aryl such as phenyl, naphthyl, anthryl and phenanthryl; alkylaryl such as o-, m-, p-tolyl, xylyl and ethylphenyl; aralkyl, such as benzyl, and α- and β-phenylethyl; of which methyl, ethyl, n-propyl, and isopropyl are preferred, and methyl is particularly preferred. Depending on the desired requirement of branching of the organopolysiloxane, branching units are added during the emulsification process. 0.1 to 5% branching units of the emulsion are useful to make an emulsion containing organopolysiloxane having a highly branched structure. The quantity used in the emulsion must be controlled carefully, otherwise gelation of the polymer may occur during the emulsion process and the emulsion will destabilize. If branched polysiloxane is not required, the silane addition is avoided.

According to the present invention, an anionic emulsifier has an important role for simple and faster emulsion processing of high internal phase viscosity emulsions with the required particle size. An anionic surfactant is selected from organic sulfonic acids. Most common sulfonic acids used in the present process are alkylaryl sulfonic acid; alkylaryl polyoxyethylene sulphonic acid; alkyl sulfonic acid; and alkyl polyoxyethylene sulfonic acid. Structures of sulfonic acids are as shown below:

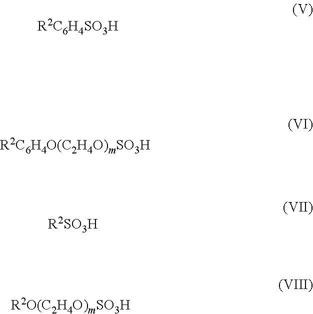

Where R², which may differ, is a monovalent hydrocarbon radical having at least 6 carbon atoms. The most preferable R² groups, but not limited to the following groups, are hexyl, octyl, decyl, dodecyl, cetyl, stearyl, myristyl, and oleyl. ‘m’ is an integer from 1 to 25. The most preferable anionic surfactants used in the present inventions are octylbenzene sulfonic acid; dodecylbenzene sulfonic acid; cetylbenzene sulfonic acid; alpha-octyl sulfonic acid; alpha-dodecyl sulfonic acid; alpha-cetyl sulfonic acid; polyoxyethylene octylbenzene sulfonic acid; polyoxyethylene dodecylbenzene sulfonic acid; polyoxyethylene cetylbenzene sulfonic acid; polyoxyethylene octyl sulfonic acid; polyoxyethylene dodecyl sulfonic acid; and polyoxyethylene cetyl sulfonic acid. Generally, 1 to 15% anionic surfactant is used in the present emulsion process. Preferably, 3-10% anionic surfactant is used to obtain the optimum result. Anionic surfactant has a dual role in the present emulsion process. Anionic surfactant acts as a condensation/ring opening catalyst together with a surfactant for emulsion making. Thus, by using an anionic emulsifier, the process does not require any catalyst for polymer growth of organopolysiloxane during the emulsion process.

HLB values are typically referred to the values at room temperature (25° C.). As temperature varies, the HLB value of a surfactant may also vary. Calculation of HLB value of non-ionic surfactants is calculated according to the equations: HLB=(E+P)/5; E=weight percentage of oxyethylene content; P=weight percentage of polyhydric alcohol content (glycerol, sorbitol, etc.) provided according to the terms of the HLB system of emulsifier classification introduced by Griffin, W. C., “Calculation of HLB Values of non-ionic Surfactants”, Journal of COSMETIC SCIENCE, Vol. 5, No. 4, January 1954, 249-256 (1954).

For ionic surfactants, the HLB value of individual surfactant molecules can be calculated applying the Davies formula as described in Davies JT (1957), “A quantitative kinetic theory of emulsion type, I. Physical chemistry of the emulsifying agent”, Gas/Liquid and Liquid/Liquid Interface (Proceedings of the International Congress of Surface Activity): 426-38.

According to the formula the HLB is derived by summing the hydrophilic/hydrophobic contributions afforded by the structural components of the surfactant. HLB=(hydrophilic group numbers)-n (group number per CH₂ group)+7 For example, Tetradecyl trimethyl ammonium chloride has the following structure:

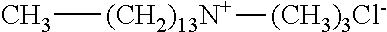

Group contribution of the hydrophobic groups: —CH₂/—CH₃−0.475
Group contribution of the hydrophilic group: N⁺—(CH₃)₃ Cl⁻ 22.0

$$HLB = 22 - ( 14 \times 0.475 ) + 7 = 22.4$$

Approximate HLB values for some cationic emulsifier are given in Table IV, in Cationic emulsifiers in cosmetics, K. M. GODFREY, J. Soc. Cosmetic Chemists 17 17-27 (1966).

Emulsifiers mixture having HLB value in between 10-16 are suitable to make the emulsion process simpler. When two emulsifiers A and B of known HLB are thus blended for use the HLB_{Mix} is said to be the required HLB for the mixture. This is expressed by the equation (W_{A}HLB_{A}+W_{B}HLB_{B})/(W_{A}+W_{B})=HLB_{Mix}, where W_{A}=the amount (weight) of the first emulsifier (A) used, and W_{B}=the amount (weight) of the second emulsifier (B); HLB_{A}, HLB_{B}=the assigned HLB values for emulsifiers A and B; HLB_{Mix}=the HLB of the mixture.

It is also observed according to the present invention, that at least one additional emulsifier together with an anionic emulsifier is essential along with the controlled temperature of emulsification and polymerization for making the emulsion in a simple and faster way. It is especially found, by way of the present invention, that at least one non-ionic emulsifier, in concert with anionic surfactant helps for faster and simpler emulsion production. Non-ionic emulsifiers having an HLB value of 10 to 19 are suitable to make the emulsion process simpler. The most useful surfactants of this category are polyoxyalkylene alkyl ether, polyoxyalkylene alkylphenyl ethers and polyoxyalkylene sorbitan esters. Some useful surfactants having an HLB value of 10 to 19 are polyethylene glycol octyl ether; polyethylene glycol lauryl ether; polyethylene glycol tridecyl ether; polyethylene glycol cetyl ether; polyethylene glycol stearyl ether; polyethylene glycol nonylphenyl ether; polyethylene glycol dodecylphenyl ether; polyethylene glycol cetylphenyl ether; polyethylene glycol stearylphenyl ether; polyethylene glycol sorbitan mono stearate; and polyethylene glycol sorbitan mono oleate. A non-ionic surfactant having the proper HLB value has great importance in the present invention to make process simpler.

In some cases, for boosting the non-ionic surfactant and anionic surfactant emulsification efficiency, an alkylene glycol or polyalkylene glycol used in together with non-ionic surfactant or anionic surfactant or mixture of both. Common alkylene glycol or polyalkylene glycol include ethylene glycol, propylene glycol, butylene glycol, polyethylene glycol, poly propylene glycol, polybutylene glycol. In some cases, 1 to 25% alkylene glycol or polyalkylene glycol is used in the emulsion-making process.

Generally, 1 to 25% non-ionic surfactant is used in the emulsion-making process. Preferably, 5-20% non-ionic surfactant is used in the present emulsion to obtain the optimum result. It is well known in the art that surfactant(s) having an HLB value between 12 and 15 are useful to make organopolysiloxane emulsion by using standard homogenizer in a shorter time period and it is also well known to use a mixture of surfactants that has an HLB value of 12 to 15 to get an emulsion of organopolysiloxane having long stability.

According to the present invention, it is also important to provide selective formulation of the emulsifiers in a ratio such that the mixture has an HLB value of preferably 12 to 15 with at least one anionic surfactant and one non-ionic surfactant in the mixture.

An important aspect in the present emulsion process is the selective use of a mixture of surfactants, which not only make stable emulsions in a faster way by using a standard homogenizer of the required particle size (less than 2 micron, which is measured by using a device ZetaSizer from Malvern). Particle size of the emulsion is highly dependent on the ratio of anionic and non-ionic emulsifier(s) in the mixture having an HLB value of 12 to 15.

It is also well known in the art that polymer growth rate of the orgaopolyisiloxane is also highly dependent on the particle size of the emulsion. Thus, polymer growth rate of the organopolysiloxane during the emulsion process is much higher compared to organopolysiloxane emulsion of the desired particle size.

According to the present invention, the temperature during the emulsion process has an important role in controlling the particle size of the emulsion, the particle size distribution (i.e polydispersibility: a value of 1 is poor and a value of 0.1 or less is very good), and the polymer growth rate of the organopolysiloxane during the emulsion process. It is also observed in the present emulsion process that particle size, distribution of the particles, and polymer viscosity become out of control if temperature is not maintained within a selective limit. It is found that a significant deviation of final emulsion specifications take place where temperature control is not within the selective range even though emulsion is produced by using an optimum combination of emulsifiers with a proper combination of fluid and emulsifier. Maintaining a temperature below 40° C. is useful to control the particle size, distribution of particles in the emulsion, and polymer growth rate of the organopolysiloxane in the emulsion.

Further, it is also important to control the emulsion temperature during the aging of the emulsion in case of ultra-high molecular weight (more than 2 million mPa·s at 25° C.) organopolysiloxane polymers in the emulsion. A temperature below 16° C. is useful to make the polymerization faster in the case of ultra-high molecular weight organopolysiloxane polymers required in the inner phase of the emulsion. Emulsion polymerization is significantly reduced if the temperature is more than 30° C. during the aging process, and it is very difficult to achieve ultra-high viscosity at high temperature. Thus, it is clear that for faster completion of the emulsion process for high molecular weight organopolysiloxane polymer to ultra-high molecular weight polymer emulsions by an emulsion polymerization process, temperature has a great role during the emulsion making process and during the aging process, and such processes may not happen at an optimum rate if the temperature is below 5° C. Thus, according to the present process, a combination of mixed silicone with mixed emulsifiers having an HLB value between 12 and 15 (containing at least one anionic emulsifier and at least one non-ionic emulsifier) together with temperature control during emulsion preparation and during aging, helps the emulsion process to produce useful emulsions of the required particle size (less than 2 micron, which is measured by using a device ZetaSizer from Malvern) with the required particle size with a standard homogenizer in commercial scale.

The components are homogenized by standard homogenizers. A useful standard shear stirring system may be used such as a conventional single-stage stator-rotor homogenizer or other types of standard homogenizers which are used in the normal homogenizing process. Homogenizing can be carried out in batch or continuously depending on the design of emulsion process. From the capital investment point of view, it is also clear that the process needs an economical homogenizing system and avoids the use of the expensive ultra-high-pressure homogenizing system.

Importantly, it is found by way of the present invention that the emulsions obtained following the process of the invention are highly stable. Tests revealed that when an emulsion obtained was put in the oven in the range of 45 to 60° C., and most preferably, 50° C., for one year, no creaming or separation or deformation in the emulsion was observed. A study of 12-hour freeze/thaw cycles in 10° C./50° C. temperature for one month also showed no creaming or separation or deformation in the emulsion.

Silicone Oil Viscosity Measurement from Emulsion

The polymer is separated from Emulsion Polymerization type of emulsion in the following way.

Take 20-25 g silicone emulsion in a 1000 ml beaker. Pour isopropyl alcohol (IPA) around 3 times of the amount of emulsion. Mix it properly by a spatula until the polymer is separated.

Set aside the mixture for two minutes to allow the polymer phase separate out of the solution.

Decant off the aqueous (IPA/water) layer and save the polymer. Repeat steps at least three times with IPA to remove the surfactant and water from the polymer.

The washing depends upon the clarity of the polymer. Place the polymer in a petri-dish (100 mm dia.) and dry in an air-circulating oven at 500 C for 24 hrs. Cool to room temperature before measurement.

Viscosity Measurement process: Switch on the Compressor and dryer, wait for 15-20 min. until pressure level reaches 5.0 kg/cm², check with the pressure gauge set in the Lab. Open the air line, and switch on the Chiller. Now switch on the machine Rheometer. Anton Paar, Germany, Model: MCR 101. Switch on the PC, open the “Start Rheoplus” software. After initialization, set 25 mm/60 cone and make zeroing the gap. Lift the cone 30 mm and place a small amount of sample on the plate. Set the measurement at a shear rate of 1 S⁻¹ for 2 minutes at 25° C. Two to three measurements are to be made for each sample and the viscosity values of 60 sec. are to be taken.

### Emulsion Particle Size Measurement

Shake the sample before measurement. The sample is prepared by weighing 0.5 g sample in a 250 ml beaker. Take 100 ml DM water in a measuring cylinder. Pour small amount of DM water into it. Mix properly with a spatula. Add the remaining water into it. Dilution should be perfectly homogenous. If required filter the test solution Immediately go to the following measurement process.

Switch on the Instrument first (Zetasizer [Make: Malvern, UK; Model: Nano-S, Software version: v7.11]) and then start PC. Open the “Zetasizer software” by double clicking the icon on the Desktop. Click “OK” to enter Now go to “File”-> “Open”-> “Measurement file”. Select the file specific for the material. Open the required file if it is already created. Otherwise click “New” to create a new file. Now go to “Measure”-> “Manual”->Enter Sample Name Go to “Material”->select the particular R.I. specific for the material. Click “OK”. Pour the sample test solution in a fresh cuvette cell as shown in the image given on the sample compartment lid. Place the cuvette inside its slot in the instrument and close the lid. Now press “Start”.

After optimizing the measurement settings, it will start performing measurement. Press “Start” if you like to repeat the measurement, otherwise close the “Manual measurement—size” window. Note down the results—Z-average, PDI, D(50), D(90) etc. as per requirement.

To see the graph of a record, select first that particular record, then click “Volume PSD (M)”. Where, D (50) value represents the median diameter i.e. portions of particles with diameters smaller than this value are 50%.

PDI is defined as the standard deviation (σ) of the particle diameter distribution divided by the mean particle diameter. PDI is used to estimate the average uniformity of a particle solution, and larger PDI values correspond to a larger size distribution.

Emulsion storage stability at 50° C.: Take about 250 μm emulsion in 400 ml glass container having cap to close the glass container mouth. Place the glass container after tightly closed the glass container mouth by cap and place it inside a air circulating oven and maintained oven temperature 50±1° C. Observation is carried out in every week till 1 year if emulsion is stable for longer period of time. Creaming: if upper surface of the emulsion in glass container is become thick and solid contained (5 μm sample/105 C/4 hr) shows more than 5% higher than initial value, then it is considered the creaming formation happening. If this cream formation value is increased in next two weeks from 1st cream formation observation, then emulsion is discarded due to stability problem (non-stable). Water separation: if water separated at the bottom of the glass container (by visual observation), then emulsion stability study is stopped for that emulsion since emulsion become destabilized due to water separated at the bottom.

Cyclosiloxane(s) (D4/D5 & D6) content in emulsion (extract a sample with acetone containing a known amount of an internal standard) and fluid is measured by GC according to CES, Silicone Europe method Quantification of residual amounts of Volatile Siloxanes in silicone products, published 17 Jul. 2014

The details of the invention, its objects and advantages are explained hereunder in greater detail in relation to non-limiting exemplary illustrations of the process:

### EXAMPLES

### Example 1 (Inventive Results with Mixture of OH Polymer)

Loaded 24 kg OH polymer 5000 mPa·s (at 25° C.) & 24 Kg OH polymer 80 mPa·s (at 25° C.) in the reactor. Started the mixing of the fluids (mixed fluid viscosity approx. 850 mPa·s at 25° C.) & cooled the fluid below 20° C., added 0.9 Kg trideceth 10 & 2.13 Kg neutralized TEA-dodecylbenzene sulfonate (approx. 30% LABSA from total quantity added) and 3 kg water. Started the mixing for better cream formation. Started homogenizing and followed the same homogenizing process where the components were mixed by single stage stator-rotor homogenizer till particle size dropped to desire level. At the cream stage, maximum cream viscosity was 600000 mPa·s at 25° C. There was no problem in circulation of cream by pump at the time of maximum cream viscosity. Circulation of cream at homogenization stage was very critical for maintaining uniform particle size & to achieve desire particle size and long-term emulsion stability. To carry out the homogenizing process, about 41 Kg water added in smaller portion by splitting the water in 6-8 portions. During homogenization, always maintained emulsion temperature below 30° C. Transferred the emulsion to cooling tank, when temperature reached 10° C., added 3.32 Kg dodecyl benzene sulfonic acid (70% of the total LABSA) to the emulsion to start the polymerization reaction. Maintained emulsion temperature around 8-10° C. for polymer growth in emulsion. After 11 hours, polymer in the emulsion reached to more than 1 Mio mPa·s at 25° C. and then, neutralized the emulsion by triethanol amine (TEA) and added desire amount of biocide for protecting against micro-contamination. The D4 level was 830 ppm, D5 level was 237 ppm, and the D6 level was 402 ppm.

$$Silicone polymer viscosity at 25 ° C . = 1.2 Mio mPa . s$$

$$Particle size ( D 50 ) = 191 nm , PDI = 0.028$$

Emulsion storage stability at 50° C. after 1 year=No separation of emulsion at bottom of the glass bottle & no cream formation at the top of emulsion

### Example 2 (Non-Inventive: Comparative Example)

Loaded 48 kg OH polymer 850 mPa·s (at 25° C.) in the reactor. Started stirring & cooled the fluid below 20° C., 0.9 Kg trideceth 10 & 2.13 Kg neutralized TEA-dodecylbenzene sulfonate (approx. 30% LABSA from total quantity) and 3 kg water is added. Started the mixing for better cream formation. Started homogenizing and followed the same homogenizing process where the components were mixed by single stage stator-rotor homogenizer till particle size drop to desired level. At the cream stage, maximum cream viscosity was 850000 mPa·s at 25° C. There was big problem in circulation of cream by pump at the time of maximum cream viscosity. To circulate the cream, added additional quantity 8 kg water added to reduce cream viscosity. In laboratory small batch, emulsion cream in initial stage can be homogenized with any higher viscosity but it is impractical or not possible when try to carry out homogenizing of high viscosity cream beyond certain viscosity value in pilot scale or production scale. Circulation of cream at homogenization stage is very critical for maintaining uniform particle size & to achieve desire particle size and long-term emulsion stability. In this case, due to high cream viscosity & addition of extra water can cause problem in emulsion quality. To carry out the homogenizing process, about 33 Kg water added in smaller portion by splitting the water in 6-8 portions. During homogenization, always maintained emulsion temperature below 30° C. Transferred the emulsion to cooling tank, when temperature reached 10° C., added 3.32 Kg dodecyl benzene sulfonic acid (70% of the total LABSA) to the emulsion to start the polymerization reaction. Emulsion was kept for polymer growth. When polymer viscosity reached more than 1 Mio mPa·s at 25° C. in 12 hrs., neutralized the emulsion by triethanol amine (TEA) and added desire amount of biocide for protecting against micro-contamination. The D4 level is 980 ppm, D5 level is 330 ppm, and the D6 level is 456 ppm.

$$Silicone polymer viscosity at 25 ° C . = 1.22 Mio mPa . s$$

$$Particle size ( D 50 ) = 221 nm , PDI = 0. 52$$

Emulsion storage stability at 50° C.=After 1 month, water separated at the bottom of the glass bottle & emulsion was destabilized

### Example 3 (Non-Inventive: Comparative Example)

Loaded 48 kg OH polymer 850 mPa·s (at 25° C.) in the reactor. Started stirring & cooled the fluid below 20° C., added 0.9 Kg trideceth 10 & 2.13 Kg neutralized Na-dodecylbenzene sulfonate (approx. 30% LABSA from total quantity added) and 3 kg water. Started the mixing for better cream formation. Started homogenizing and followed the same homogenizing process where the components were mixed by single stage stator-rotor homogenizer till particle size drop to desired level. At the cream stage, maximum cream viscosity was 100000 mPa·s at 25° C. There was big problem in circulation of cream by pump at the time of maximum cream viscosity & cream became very much dry type mass. To circulate the cream, added additional quantity 15 kg water added to reduce cream viscosity. In laboratory small batch, emulsion cream in initial stage can be homogenized with any higher viscosity but it is impractical or not possible when try to carry out homogenizing of high viscosity cream beyond certain viscosity value in pilot scale or production scale Circulation of cream at homogenization stage is very critical for maintaining uniform particle size & to achieve desire particle size and long-term emulsion stability. In this case, due to high cream viscosity & addition of extra water can cause problem in emulsion quality. To carry out the homogenizing process, about 26 Kg water added in smaller portion by splitting the water in 6-8 portions. During homogenization, always maintained emulsion temperature below 30° C. Transferred the emulsion to cooling tank and when emulsion temperature reached to 10° C., added 3.32 Kg dodecyl benzene sulfonic acid (70% of the total LABSA) to the emulsion to start the polymerization reaction, emulsion was kept for polymer growth. When viscosity reached more than 1 Mio mPa·s at 25° C. in 15.9 hrs, neutralized the emulsion by triethanol amine (TEA) and added desire amount of biocide for protecting against micro-contamination. The D4 level is 1300 ppm, D5 level is 790 ppm, and the D6 level is 910 ppm.

$$Silicone polymer viscosity at 25 ° C . = 1.15 Mio mPa . s$$

$$Particle size ( D 50 ) = 361 nm , PDI = 1.$$

Emulsion storage stability at 50° C.=After 1 week (7 days), water separated at the bottom of the glass bottle & emulsion was destabilized

### Example 4 (Non-Inventive: Comparative Example 1 of U.S. Pat. No. 9,765,189B2)

Loaded 50 kg OH polymer in the reactor having D4 content 35 ppm & viscosity 700 mm²/s mPa·s (kinematic viscosity at 25° C.). Started stirring & added 1 Kg trideceth 10 & 1.75 Kg neutralized Na-dodecylbenzene sulfonate and 3 kg water. Started the mixing for better cream formation. Started homogenizing and followed the same homogenizing process where the components were mixed by single stage stator-rotor homogenizer till particle size drop to desired level. At the cream stage, maximum cream viscosity was 110000 mPa·s at 25° C. There was big problem in circulation of cream by pump at the time of maximum cream viscosity & cream became very much dry type mass. To circulate the cream, added additional quantity 17 kg water added to reduce cream viscosity. In laboratory small batch, emulsion cream in initial stage can be homogenized with any higher viscosity but it is impractical or not possible when try to carry out homogenizing of high viscosity cream beyond certain viscosity value in pilot scale or production scale. Circulation of cream at homogenization stage is very critical for maintaining uniform particle size & to achieve desire particle size and long-term emulsion stability. In this case, due to high cream viscosity & addition of extra water can cause problem in emulsion quality. To carry out the dilution process, about 27.45 Kg water added under stirring condition. Transferred the emulsion to cooling tank. When emulsion temperature reached to 10° C., added 0.6 Kg conc hydrochloric acid to the emulsion to start the polymerization reaction. Emulsion was kept for polymer growth. When emulsion viscosity reached more than 1 Mio mPa·s at 25° C. in 22.5 hrs., neutralize the emulsion by 1.2 kg triethanol amine (TEA) and added desire amount of biocide for protecting against micro-contamination. The D4 level is 2000 ppm, D5 level is 1540 ppm, and the D6 level is 1290 ppm.

$$Silicone polymer viscosity at 25 ° C . = 1.07 Mio mPa . s$$

$$Particle size ( D 50 ) = 700 nm , PDI = 1.$$

Emulsion storage stability at 50° C.=After 1 week (7 days), water separated at the bottom of the glass bottle & emulsion was destabilized

### Example 5 (Non-Inventive: Comparative Example 2 of U.S. Pat. No. 9,765,189B2)

Loaded 50 kg OH polymer in the reactor having D4 content 35 ppm & viscosity 700 mm²/s mPa·s (kinematic viscosity at 25° C.). Started stirring & added 3.5 Kg dodecylbenzene sulfonic acid and 3 kg water. Started the mixing for better cream formation. Started homogenizing and followed the same homogenizing process where the components were mixed by single stage stator-rotor homogenizer till particle size drop to desired level. At the cream stage, maximum cream viscosity was 115000 mPa·s at 25° C. There was big problem in circulation of cream by pump at the time of maximum cream viscosity & cream became very much dry type mass. To circulate the cream, added additional quantity 18 kg water added to reduce cream viscosity. In laboratory small batch, emulsion cream in initial stage can be homogenized with any higher viscosity but it is impractical or not possible when try to carry out homogenizing of high viscosity cream beyond certain viscosity value in pilot scale or production scale. Circulation of cream at homogenization stage is very critical for maintaining uniform particle size & to achieve desire particle size and long-term emulsion stability. In this case, due to high cream viscosity & addition of extra water can cause problem in emulsion quality. To carry out the dilution process, about 23.25 Kg water added under stirring condition. Transferred the emulsion to cooling tank and cooled emulsion to 10° C. and kept the emulsion for polymer growth. When viscosity reached more than 1 Mio mPa·s at 25° C. in 15 hrs., neutralize the emulsion by 2.25 kg triethanol amine (TEA) and added desire amount of biocide for protecting against micro-contamination. The D4 level is 4000 ppm, D5 level is 2540 ppm, and the D6 level is 1150 ppm.

$$Silicone polymer viscosity at 25 ° C . = 1.1 Mio mPa . s$$

$$Particle size ( D 50 ) = 1194 nm , PDI = 1.$$

Emulsion storage stability at 50° C.=After 1 week (7 days), water separated at the bottom of the glass bottle & emulsion was destabilized

### Example 6 (Non-Inventive: Comparative Example 3 of U.S. Pat. No. 9,765,189B2)

Loaded 50 kg OH polymer in the reactor having D4 content 38 ppm & viscosity 1500 mm²/s mPa·s (kinematic viscosity at 25° C.). Started stirring & added 1.5 Kg trideceth 10 & 2.0 Kg neutralized Na-dodecylbenzene sulfonate and 3 kg water. Started the mixing for better cream formation. Started homogenizing and followed the same homogenizing process where the components were mixed by single stage stator-rotor homogenizer till particle size drop to desired level. At the cream stage, maximum cream viscosity was 120000 mPa·s at 25° C. There was big problem in circulation of cream by pump at the time of maximum cream viscosity & cream became very much dry type mass. To circulate the cream, added additional quantity 18 kg water added to reduce cream viscosity. In laboratory small batch, emulsion cream in initial stage can be homogenized with any higher viscosity but it is impractical or not possible when try to carry out homogenizing of high viscosity cream beyond certain viscosity value in pilot scale or production scale. Circulation of cream at homogenization stage is very critical for maintaining uniform particle size & to achieve desire particle size and long-term emulsion stability. In this case, due to high cream viscosity & addition of extra water can cause problem in emulsion quality. To carry out the dilution process, about 23.7 Kg water added under stirring condition. Transferred the emulsion to cooling tank, when temperature reaches 10° C., add 0.6 Kg conc hydrochloric acid to the emulsion to start the polymerization reaction. Emulsion was kept the emulsion for polymer growth. When viscosity reached more than 1 Mio mPa·s at 25° C. in 22.5 hrs, neutralized the emulsion by 1.2 kg triethanol amine (TEA) and added desire amount of biocide for protecting against micro-contamination. The D4 level is 2200 ppm, D5 level is 1670 ppm, and the D6 level is 1380 ppm.

$$Silicone polymer viscosity at 25 ° C . = 1.12 Mio mPa \cdot s$$

$$Particle size ( D 50 ) = 1250 nm , PDI = 1.$$

Emulsion storage stability at 50° C.=After 1 week (7 days), water separated at the bottom of the glass bottle & emulsion was destabilized

### Example 7 (Non-Inventive: Comparative Example) (High Temperature During Creaming and Homogenization)

Loaded 24 kg OH polymer 5000 mPa·s (at 25° C.) & 24 Kg OH polymer 80 mPa·s (at 25° C.) in the reactor. Started the mixing of the fluids (mixed fluid viscosity approx. 850 mPa·s at 25° C.) & added 0.9 Kg trideceth 10 & 2.13 Kg neutralized TEA-dodecylbenzene sulfonate (approx. 30% LABSA from total quantity added) and 3 kg water. Started the mixing for better cream formation. Started homogenizing and followed the same homogenizing process where the components were mixed by single stage stator-rotor homogenizer till particle size dropped to desire level. At the cream stage, maximum cream viscosity was 10000 mPa·s at 25° C. There was no problem in circulation of cream by pump at the time of maximum cream viscosity. Cream viscosity at homogenizing stage was very low which normally had had a problem in stability. It was happened due to high cream temperature (approx. 37° C.). To carry out the homogenizing process, about 41 Kg water added in smaller portion by splitting the water in 6-8 portions. During homogenization, always maintained emulsion temperature in between 35-39° C. Transferred the emulsion to cooling tank, when temperature reached 10° C., added 3.32 Kg dodecyl benzene sulfonic acid (70% of the total LABSA) to the emulsion to start the polymerization reaction. Maintained emulsion temperature around 8-10° C. for polymer growth in emulsion. After 12 hr., polymer in the emulsion reached to more than 1 Mio mPa·s at 25° C. and then, neutralized the emulsion by triethanol amine (TEA) and added desire amount of biocide for protecting against micro-contamination. The D4 level was 900 ppm, D5 level was 390 ppm, and the D6 level was 429 ppm.

$$Silicone polymer viscosity at 25 ° C . = 1.1 Mio mPa \cdot s$$

$$Particle size ( D 50 ) = 1500 nm , PDI = 1.$$

Emulsion storage stability at 50° C.=Separated immediately after completion of emulsion production> There was no requirement to keep it temperature oven

### Example 8 (Non-Inventive: Comparative Example) (Single Starting OH Polymer and High Creaming and Homogenization Temperature)

Loaded 48 kg OH polymer 850 mPa·s (at 25° C.). Started the mixing the fluid & added 0.9 Kg trideceth 10 & 2.13 Kg neutralized TEA-dodecylbenzene sulfonate (approx. 30% LABSA from total quantity added) and 3 kg water. Started the mixing for better cream formation. Started homogenizing and followed the same homogenizing process where the components were mixed by single stage stator-rotor homogenizer till particle size dropped to desire level. At the cream stage, maximum cream viscosity was 8000 mPa·s at 25° C. There was no problem in circulation of cream by pump at the time of maximum cream viscosity. Cream viscosity at homogenizing stage was very low which normally had had a problem in stability. It was happened due to high cream temperature (approx. 38° C.). To carry out the homogenizing process, about 41 Kg water added in smaller portion by splitting the water in 6-8 portions. During homogenization, always maintained emulsion temperature in between 35-39° C. Transferred the emulsion to cooling tank, when temperature reached 10° C., added 3.32 Kg dodecyl benzene sulfonic acid (70% of the total LABSA) to the emulsion to start the polymerization reaction. Maintained emulsion temperature around 8-10° C. for polymer growth in emulsion. After 12 hr., polymer in the emulsion reached to more than 1 Mio mPa·s at 25° C. and then, neutralized the emulsion by triethanol amine (TEA) and added desire amount of biocide for protecting against micro-contamination. The D4 level was 910 ppm, D5 level was 428 ppm, and the D6 level was 390 ppm.

$$Silicone polymer viscosity at 25 ° C . = 1.25 Mio mPa \cdot s$$

$$Particle size ( D 50 ) = 2500 nm , PDI = 1.$$

Emulsion storage stability at 50° C.=Separated immediately after completion of emulsion production> There was no requirement to keep it temperature oven

### Example 9 (Non-Inventive: Comparative Example, Higher Emulsion Temperature for Polymer Growth)

Loaded 24 kg OH polymer 5000 mPa·s (at 25° C.) & 24 Kg OH polymer 80 mPa·s (at 25° C.) in the reactor. Started the mixing of the fluids (mixed fluid viscosity approx. 850 mPa·s at 25° C.) & added 0.9 Kg trideceth 10 & 2.13 Kg neutralized TEA-dodecylbenzene sulfonate (approx. 30% LABSA from total quantity added) and 3 kg water. Started the mixing for better cream formation. Started homogenizing and followed the same homogenizing process where the components were mixed by single stage stator-rotor homogenizer till particle size dropped to desire level. At the cream stage, maximum cream viscosity was 600000 mPa·s at 25° C. There was no problem in circulation of cream by pump at the time of maximum cream viscosity. To carry out the homogenizing process, about 41 Kg water added in smaller portion by splitting the water in 6-8 portions. During homogenization, always maintained emulsion temperature below 30° C. Transferred the emulsion to cooling tank, when temperature reached 15° C., added 3.32 Kg dodecyl benzene sulfonic acid (70% of the total LABSA) to the emulsion to start the polymerization reaction. Maintained emulsion temperature around 15-17° C. for polymer growth in emulsion. After 22 hr, polymer in the emulsion reached to more than 1 Mio mPa·s at 25° C. and then, neutralized the emulsion by triethanol amine (TEA) and added desire amount of biocide for protecting against micro-contamination. The D4 level was 3100 ppm, D5 level was 2500 ppm, and the D6 level was 1350 ppm.

$$Silicone polymer viscosity at 25 ° C . = 1.17 Mio mPa \cdot s$$

$$Particle size ( D 50 ) = 190 nm , PDI = 0.02$$

Emulsion storage stability at 50° C. after 1 year=No separation of emulsion at bottom of the glass bottle & no cream formation at the top of emulsion

### Example 10 (Non-Inventive: Comparative Example) (Single Starting OH Polymer and Higher Emulsion Temperature for Polymer Growth)

Loaded 48 kg OH polymer 850 mPa·s (at 25° C.). Started the mixing the fluid & added 0.9 Kg trideceth 10 & 2.13 Kg neutralized TEA-dodecylbenzene sulfonate (approx. 30% LABSA from total quantity added) and 3 kg water. Started the mixing for better cream formation. Started homogenizing and followed the same homogenizing process where the components were mixed by single stage stator-rotor homogenizer till particle size drop to desired level. At the cream stage, maximum cream viscosity was 850000 mPa·s at 25° C. There was big problem in circulation of cream by pump at the time of maximum cream viscosity. To circulate the cream, added additional quantity 8 kg water added to reduce cream viscosity. In laboratory small batch, emulsion cream in initial stage can be homogenized with any higher viscosity but it is impractical or not possible when try to carry out homogenizing of high viscosity cream beyond certain viscosity value in pilot scale or production scale. Circulation of cream at homogenization stage is very critical for maintaining uniform particle size & to achieve desire particle size and long-term emulsion stability. In this case, due to high cream viscosity & addition of extra water can cause problem in emulsion quality. To carry out the homogenizing process, about 33 Kg water added in smaller portion by splitting the water in 6-8 portions. During homogenization, always maintained emulsion temperature below 30° C. Transferred the emulsion to cooling tank, when temperature reached 15° C., added 3.32 Kg dodecyl benzene sulfonic acid (70% of the total LABSA) to the emulsion to start the polymerization reaction. Maintained emulsion temperature around 15-17° C. for polymer growth in emulsion. After 25 hr., polymer in the emulsion reached to more than 1 Mio mPa·s at 25° C. and then, neutralized the emulsion by triethanol amine (TEA) and added desire amount of biocide for protecting against micro-contamination. The D4 level was 3500 ppm, D5 level was 2440 ppm, and the D6 level was 1657 ppm.

$$Silicone polymer viscosity at 25 ° C . = 1.17 Mio mPa \cdot s$$

$$Particle size ( D 50 ) = 1500 nm , PDI = 1.$$

Emulsion storage stability at 50° C.=After 1 month, water separated at the bottom of the glass bottle & emulsion was destabilized

### Example 11 (Non-Inventive: Comparative Example) (Very Low Temperature (4° C.) for Polymer Growth and is Difficult to Produce in Industrial Scale)

Loaded 24 kg OH polymer 5000 mPa·s (at 25° C.) & 24 Kg OH polymer 80 mPa·s (at 25° C.) in the reactor. Started the mixing of the fluids (mixed fluid viscosity approx. 850 mPa·s at 25° C.) & added 0.9 Kg trideceth 10 & 2.13 Kg neutralized TEA-dodecylbenzene sulfonate (approx. 30% LABSA from total quantity added) and 3 kg water. Started the mixing for better cream formation. Started homogenizing and followed the same homogenizing process where the components were mixed by single stage stator-rotor homogenizer till particle size dropped to desire level. At the cream stage, maximum cream viscosity was 600000 mPa·s at 25° C. There was no problem in circulation of cream by pump at the time of maximum cream viscosity. To carry out the homogenizing process, about 41 Kg water added in smaller portion by splitting the water in 6-8 portions. During homogenization, always maintained emulsion temperature below 30° C. Transferred the emulsion to cooling tank and temperature of the emulsion was 19° C., when temperature reached 4° C., added 3.32 Kg dodecyl benzene sulfonic acid (70% of the total LABSA) to the emulsion to start the polymerization reaction. Maintained emulsion temperature around 3-5° C. for polymer growth in emulsion. Almost 9 hrs required to drop emulsion temperature from 19° C. to 4° C. Again, after addition of dodecyl benzene sulfonic acid, emulsion become very viscous like paste and heat transferred was a big challenge & difficult to maintain. This type of emulsion can be possible to make in lab but very difficult to produce in pilot plant and impractical in commercial scale. After 48 hrs, polymer in the emulsion reached to more than 1 Mio mPa·s at 25° C. and then, neutralized the emulsion by triethanol amine (TEA) and added desire amount of biocide for protecting against micro-contamination. The D4 level was 6100 ppm, D5 level was 4550 ppm, and the D6 level was 3520 ppm.

$$Silicone polymer viscosity at 25 ° C . = 1.05 Mio mPa \cdot s$$

$$Particle size ( D 50 ) = 192 nm , PDI = 0.019$$

Emulsion storage stability at 50° C. after 1 year=No separation of emulsion at bottom of the glass bottle & no cream formation at the top of emulsion

### Example 12 (Non-Inventive: Comparative Example) (Single Starting OH Polymer and Very Low Temperature (4° C.) for Polymer Growth and is Difficult to Produce in Industrial Scale)

Loaded 48 kg OH polymer 850 mPa·s (at 25° C.). Started the mixing the fluid & added 0.9 Kg trideceth 10 & 2.13 Kg neutralized TEA-dodecylbenzene sulfonate (approx. 30% LABSA from total quantity added) and 3 kg water. Started the mixing for better cream formation. Started homogenizing and followed the same homogenizing process where the components were mixed by single stage stator-rotor homogenizer till particle size drop to desired level. At the cream stage, maximum cream viscosity was 850000 mPa·s at 25° C. There was big problem in circulation of cream by pump at the time of maximum cream viscosity. To circulate the cream, added additional quantity 8 kg water added to reduce cream viscosity. In laboratory small batch, emulsion cream in initial stage can be homogenized with any higher viscosity but it is impractical or not possible when try to carry out homogenizing of high viscosity cream beyond certain viscosity value in pilot scale or production scale. Circulation of cream at homogenization stage is very critical for maintaining uniform particle size & to achieve desire particle size and long-term emulsion stability. In this case, due to high cream viscosity & addition of extra water can cause problem in emulsion quality. To carry out the dilution process, about 33 Kg water added under stirring condition. During homogenization & dilution process, always maintained emulsion temperature below 30° C. Transferred the emulsion to cooling tank and temperature of the emulsion was 19° C., when temperature reached 4° C., added 3.32 Kg dodecyl benzene sulfonic acid (70% of the total LABSA) to the emulsion to start the polymerization reaction. Maintained emulsion temperature around 3-5° C. for polymer growth in emulsion. Almost 9 hrs required to drop emulsion temperature from 19° C. to 4° C. Again, after addition of dodecyl benzene sulfonic acid, emulsion become very viscous like paste and heat transferred was a big challenge & difficult to maintain. This type of emulsion can be possible to make in lab but very difficult to produce in pilot plant and impractical in commercial scale. After 55 hr., polymer in the emulsion reached to more than 1 Mio mPa·s at 25° C. and then, neutralized the emulsion by triethanol amine (TEA) and added desire amount of biocide for protecting against micro-contamination. The D4 level was 7500 ppm, D5 level was 4700 ppm, and the D6 level was 3250 ppm.

$$Silicone polymer viscosity at 25 ° C . = 1.01 Mio mPa \cdot s$$

$$Particle size ( D 50 ) = 1700 nm , PDI = 1.$$

Emulsion storage stability at 50° C.=After 1 month, water separated at the bottom of the glass bottle & emulsion was destabilized

### Example 13 (Non-Inventive: Comparative Example U.S. Pat. No. 9,895,296B2, Example A (Single Starting OH Polymer with Higher Viscosity))

Loaded 50 kg OH polymer 5000 mPa·s (at 25° C.). Started the mixing the fluid & added 0.0.375 Kg laureth −4, 1.125 Kg laureth −23 & 2.0 Kg neutralized Na-dodecylbenzene sulfonate and 2 kg water. Started the mixing for better cream formation. Started homogenizing and followed the same homogenizing process where the components were mixed by single stage stator-rotor homogenizer till particle size drop to desired level. At the cream stage, maximum cream viscosity was 950000 mPa·s at 25° C. There was big problem in circulation of cream by pump at the time of maximum cream viscosity. To circulate the cream, added additional quantity 10 kg water added to reduce cream viscosity. In laboratory small batch, emulsion cream in initial stage can be homogenized with any higher viscosity but it is impractical or not possible when try to carry out homogenizing of high viscosity cream beyond certain viscosity value in pilot scale or production scale. Circulation of cream at homogenization stage is very critical for maintaining uniform particle size & to achieve desire particle size and long-term emulsion stability. In this case, due to high cream viscosity & addition of extra water can cause problem in emulsion quality. To carry out the dilution process, about 31.6 Kg water added-under stirring condition. During homogenization & dilution process, always maintained emulsion temperature below 30° C. Transferred the emulsion to cooling tank and temperature of the emulsion was 20° C., when temperature reached 0° C., added 0.6 Kg concentrate hydrochloric acid in the emulsion to start the polymerization reaction. Maintained emulsion temperature around 0-2° C. for polymer growth in emulsion. Almost 14 hrs required to drop emulsion temperature from 19° C. to 0° C. Again, after addition of hydrochloric acid, emulsion become very viscous like paste and heat transferred was a big challenge & difficult to maintain. This type of emulsion can be possible to make in lab but very difficult to produce in pilot plant and impractical in commercial scale. After 60 hr, polymer in the emulsion reached to more than 1 Mio mPa·s at 25° C. and then, neutralized the emulsion by 3.2 sodium carbonate emulsion (10% active) and added desire amount of biocide for protecting against micro-contamination. The D4 level was 6500 ppm, D5 level was 4700 ppm, and the D6 level was 3250 ppm.

$$Silicone polymer viscosity at 25 ° C . = 2.05 Mio mPa \cdot s$$

$$Particle size ( D 50 ) = 1700 nm , PDI = 1.$$

Emulsion storage stability at 50° C.=After 1 month, water separated at the bottom of the glass bottle & emulsion was destabilized

### Example 14 (Inventive Results with Mixture of OH Polymer) (Inventive Composition Having Mixture of OH Polymer in Different Ratio)

Loaded 10.25 kg OH polymer 5000 mPa·s (at 25° C.) & 30.75 Kg OH polymer 80 mPa·s (at 25° C.) in the reactor. Started the mixing of the fluids (mixed fluid viscosity approx. 350 mPa·s at 25° C.) & cooled the fluid below 20° C., Added 4.6 Kg trideceth 10; 1.2 kg propylene & 4.5 Kg neutralized TEA-dodecylbenzene sulfonate and 5 kg water. Started the mixing for better cream formation. Started homogenizing and followed the same homogenizing process where the components were mixed by single stage stator-rotor homogenizer till particle size dropped to desire level. At the cream stage, maximum cream viscosity was 650000 mPa·s at 25° C. There was no problem in circulation of cream by pump at the time of maximum cream viscosity. Circulation of cream at homogenization stage was very critical for maintaining uniform particle size & to achieve desire particle size and long-term emulsion stability. To carry out the homogenizing process, about 36 Kg water added in smaller portion by splitting the water in 6-8 portions. During homogenization, always maintained emulsion temperature below 30° C. Transferred the emulsion to cooling tank, when temperature reached 10° C., added 2.5 Kg dodecyl benzene sulfonic acid to the emulsion to start the polymerization reaction. Maintained emulsion temperature around 8-10° C. for polymer growth in emulsion. After 13 hr., polymer in the emulsion reached to more than 1 Mio mPa·s at 25° C. and then, neutralized the emulsion by triethanol amine (TEA) and added desire amount of biocide for protecting against micro-contamination. The D4 level was 930 ppm, D5 level was 277 ppm, and the D6 level was 435 ppm.

$$Silicone polymer viscosity at 25 ° C . = 1.1 Mio mPa \cdot s$$

$$Particle size ( D 50 ) = 99 nm , PDI = 0.015$$

Emulsion storage stability at 50° C. after 1 year=No separation of emulsion at bottom of the glass bottle & no cream formation at the top of emulsion

### Example 15 (Inventive Results with Mixture of OH Polymer) (Inventive Composition Having Mixture of OH Polymer in Different Ratio)

Loaded 44.25 kg OH polymer 5000 mPa·s (at 25° C.) & 14.75 Kg OH polymer 80 mPa·s (at 25° C.) in the reactor. Started the mixing of the fluids (mixed fluid viscosity approx. 1250 mPa·s at 25° C.) & cooled the fluid below 20° C., Added 0.9 Kg trideceth 10 & 0.9 Kg neutralized TEA-dodecylbenzene sulfonate and 5 kg water. Started the mixing for better cream formation. Started homogenizing and followed the same homogenizing process where the components were mixed by single stage stator-rotor homogenizer till particle size dropped to desire level. At the cream stage, maximum cream viscosity was 630000 mPa·s at 25° C. There was no problem in circulation of cream by pump at the time of maximum cream viscosity. Circulation of cream at hogenization stage was very critical for maintaining uniform particle size & to achieve desire particle size and long-term emulsion stability. To carry out the homogenizing process, about 35.6 Kg water added in smaller portion by splitting the water in 6-8 portions. During homogenization, always maintained emulsion temperature below 30° C. Transferred the emulsion to cooling tank, when temperature reached 10° C., added 0.6 Kg dodecyl benzene sulfonic acid to the emulsion to start the polymerization reaction. Maintained emulsion temperature around 8-10° C. for polymer growth in emulsion. After 17 hr, polymer in the emulsion reached to more than 1 Mio mPa·s at 25° C. and then, neutralized the emulsion by triethanol amine (TEA) and added desire amount of biocide for protecting against micro-contamination. The D4 level was 870 ppm, D5 level was 310 ppm, and the D6 level was 412 ppm.

$$Silicone polymer viscosity at 25 ° C . = 1.15 Mio mPa \cdot s$$

$$Particle size ( D 50 ) = 570 nm , PDI = 0.027$$

Emulsion storage stability at 50° C. after 1 year=No separation of emulsion at bottom of the glass bottle & no cream formation at the top of emulsion

### Example 16 (Inventive Results with OH Polymer & Trimethyl Siloxy Polydimethyl Siloxane)

Loaded 37.5 kg OH polymer 80 mPa·s (at 25° C.) & 3.5 Kg trimethyl siloxy polydimethyl siloxane-350 mPa·s (at 25° C.) in the reactor. Started the mixing of the fluids (mixed fluid viscosity approx. 150 mPa·s at 25° C.) & cooled the fluid below 20° C., Added 4.6 Kg trideceth 10; 1.2 kg propylene & 4.5 Kg neutralized TEA-dodecylbenzene sulfonate and 5 kg water. Started the mixing for better cream formation. Started homogenizing and followed the same homogenizing process where the components were mixed by single stage stator-rotor homogenizer till particle size dropped to desire level. At the cream stage, maximum cream viscosity was 600000 mPa·s at 25° C. There was no problem in circulation of cream by pump at the time of maximum cream viscosity. Circulation of cream at homogenization stage was very critical for maintaining uniform particle size & to achieve desire particle size and long-term emulsion stability. To carry out the homogenizing process, about 36 Kg water added in smaller portion by splitting the water in 6-8 portions. During homogenization, always maintained emulsion temperature below 30° C. Transferred the emulsion to cooling tank, when temperature reached 10° C., added 2.5 Kg dodecyl benzene sulfonic acid to the emulsion to start the polymerization reaction. Maintained emulsion temperature around 8-10° C. for polymer growth in emulsion. After 2 hr, polymer in the emulsion reached to desired viscosity and then, neutralized the emulsion by triethanol amine (TEA) and added desire amount of biocide for protecting against micro-contamination. The D4 level was 910 ppm, D5 level was 290 ppm, and the D6 level was 310 ppm.

$$Silicone polymer viscosity at 25 ° C . = 0.21 Mio mPa \cdot s$$

$$Particle size ( D 50 ) = 105 nm , PDI = 0.01$$

Emulsion storage stability at 50° C. after 1 year=No separation of emulsion at bottom of the glass bottle & no cream formation at the top of emulsion

### Example 17 (Inventive Results with Mixed OH Polymer & Trimethyl Silanol)

Loaded 10.25 kg OH polymer 5000 mPa·s (at 25° C.) & 30.75 Kg OH polymer 80 mPa·s (at 25° C.) and 38 μm trimethyl silanol in the reactor. Started the mixing of the fluids (mixed fluid viscosity approx. 550 mPa·s at 25° C.) & cooled the fluid below 20° C., Added 4.6 Kg trideceth 10; 1.2 kg propylene & 4.5 Kg neutralized TEA-dodecylbenzene sulfonate and 5 kg water. Started the mixing for better cream formation. Started homogenizing and followed the same homogenizing process where the components were mixed by single stage stator-rotor homogenizer till particle size dropped to desire level. At the cream stage, maximum cream viscosity was 650000 mPa·s at 25° C. There was no problem in circulation of cream by pump at the time of maximum cream viscosity. Circulation of cream at homogenization stage was very critical for maintaining uniform particle size & to achieve desire particle size and long-term emulsion stability. To carry out the homogenizing process, about 36 Kg water added in smaller portion by splitting the water in 6-8 portions. During homogenization, always maintained emulsion temperature below 30° C. Transferred the emulsion to cooling tank, when temperature reached 10° C., added 2.5 Kg dodecyl benzene sulfonic acid to the emulsion to start the polymerization reaction. Maintained emulsion temperature around 8-10° C. for polymer growth in emulsion. After 2 hr, polymer in the emulsion reached to desire level and then, neutralized the emulsion by triethanol amine (TEA) and added desire amount of biocide for protecting against micro-contamination. The D4 level was 810 ppm, D5 level was 290 ppm, and the D6 level was 319 ppm.

$$Silicone polymer viscosity at 25 ° C . = 0.22 Mio mPa \cdot s$$

$$Particle size ( D 50 ) = 107 nm , PDI = 0.01$$

Emulsion storage stability at 50° C. after 1 year=No separation of emulsion at bottom of the glass bottle & no cream formation at the top of emulsion

### Example 18 (Non-Inventive Results with Mixed OH Polymer & Trimethyl Siloxy Polydimethyl Siloxane and Non-Neutralized Dodecylbenzene Sulfonic Acid)

Loaded 37.5 kg OH polymer 80 mPa·s (at 25° C.) & 3.5 Kg trimethyl siloxy polydimethyl siloxane-350 mPa·s (at 25° C.) in the reactor. Started the mixing of the fluids & added 4.6 Kg trideceth 10:1.2 kg propylene & 3.0 Kg dodecylbenzene sulfonic acid and 5 kg water. Started the mixing for better cream formation. Started homogenizing and followed the same homogenizing process where the components were mixed by single stage stator-rotor homogenizer till particle size dropped to desire level. At the cream stage, maximum cream viscosity was 650000 mPa·s at 25° C. There was no problem in circulation of cream by pump at the time of maximum cream viscosity. Circulation of cream at homogenization stage was very critical for maintaining uniform particle size & to achieve desire particle size and long-term emulsion stability. To carry out the homogenizing process, about 36 Kg water added in smaller portion by splitting the water in 6-8 portions. During homogenization, always maintained emulsion temperature below 40° C. Transferred the emulsion to cooling tank, when temperature reached 15° C., added 2.5 Kg dodecyl benzene sulfonic acid to the emulsion to start the polymerization reaction. Maintained emulsion temperature around 15-20° C. for polymer growth in emulsion. After 1 hr, polymer in the emulsion reached to desired viscosity and then, neutralized the emulsion by triethanol amine (TEA) and added desire amount of biocide for protecting against micro-contamination. The D4 level was 4000 ppm, D5 level was 2990 ppm, and the D6 level was 1650 ppm.

$$Silicone polymer viscosity at 25 ° C . = 0.21 Mio mPa \cdot s$$

$$Particle size ( D 50 ) = 107 nm , PDI = 0.01$$

Emulsion storage stability at 50° C. after 1 year=No separation of emulsion at bottom of the glass bottle & no cream formation at the top of emulsion

### Example 19 (Non-Inventive Results with Mixed OH Polymer & Trimethyl Silanol and Higher Temperature for Polymer Growth)

Loaded 10.25 kg OH polymer 5000 mPa·s (at 25° C.) & 30.75 Kg OH polymer 80 mPa·s (at 25° C.) and 38 μm trimethyl silanol in the reactor. Started the mixing of the fluids and added 4.6 Kg trideceth 10:1.2 kg propylene & 3.0 Kg neutralized dodecylbenzene sulfonic acid and 5 kg water. Started the mixing for better cream formation. Started homogenizing and followed the same homogenizing process where the components were mixed by single stage stator-rotor homogenizer till particle size dropped to desire level. At the cream stage, maximum cream viscosity was 650000 mPa·s at 25° C. There was no problem in circulation of cream by pump at the time of maximum cream viscosity. Circulation of cream at hogenization stage was very critical for maintaining uniform particle size & to achieve desire particle size and long-term emulsion stability. To carry out the homogenizing process, about 36 Kg water added in smaller portion by splitting the water in 6-8 portions. During homogenization, always maintained emulsion temperature below 40° C. Transferred the emulsion to cooling tank, when temperature reached 15° C., added 2.5 Kg dodecyl benzene sulfonic acid to the emulsion to start the polymerization reaction. Maintained emulsion temperature around 15-20° C. for polymer growth in emulsion. After 1 hr, polymer in the emulsion reached to desire level and then, neutralized the emulsion by triethanol amine (TEA) and added desire amount of biocide for protecting against micro-contamination. The D4 level was 3890 ppm, D5 level was 3120 ppm, and the D6 level was 1910 ppm.

$$Silicone polymer viscosity at 25 ° C . = 0.23 Mio mPa \cdot s$$

$$Particle size ( D 50 ) = 101 nm , PDI = 0.01$$

Emulsion storage stability at 50° C. after 1 year=No separation of emulsion at bottom of the glass bottle & no cream formation at the top of emulsion

### Example 20 (Commercial Scale Production of Example 1 Inventive Results with Mixture of OH Polymer)

Loaded 1000 kg OH polymer 5000 mPa·s (at 25° C.) & 1000 Kg OH polymer 80 mPa·s (at 25° C.) in the reactor. Started the mixing of the fluids (mixed fluid viscosity approx. 850 mPa·s at 25° C.) & cooled the fluid below 20° C., added 40 Kg trideceth 10 & 85 Kg neutralized TEA-dodecylbenzene sulfonate (approx. 30% LABSA from total quantity added) and 120 kg water. Started the mixing for better cream formation. Started homogenizing and followed the same homogenizing process where the components were mixed by single stage stator-rotor homogenizer till particle size dropped to desire level. At the cream stage, maximum cream viscosity was 600000 mPa·s at 25° C. There was no problem in circulation of cream by pump at the time of maximum cream viscosity. Circulation of cream at homogenization stage was very critical for maintaining uniform particle size & to achieve desire particle size and long-term emulsion stability. To carry out the homogenizing process, about 1700 Kg water added in smaller portion by splitting the water in 6-8 portions. During homogenization, always maintained emulsion temperature below 30° C. Transferred the emulsion to cooling tank, when temperature reached 10° C., added 130 Kg dodecyl benzene sulfonic acid (70% of the total LABSA) to the emulsion to start the polymerization reaction. Maintained emulsion temperature around 8-10° C. for polymer growth in emulsion. After 11 hours, polymer in the emulsion reached to more than 1 Mio mPa·s at 25° C. and then, neutralized the emulsion by triethanol amine (TEA) and added desire amount of biocide for protecting against micro-contamination. The D4 level was 850 ppm, D5 level was 243 ppm, and the D6 level was 450 ppm.

$$Silicone polymer viscosity at 25 ° C . = 1.44 Mio mPa \cdot s$$

$$Particle size ( D 50 ) = 186.9 nm , PDI = 0.028$$

Emulsion storage stability at 50° C. after 1 year=No separation of emulsion at bottom of the glass bottle & no cream formation at the top of emulsion.

Thus, we see from the above examples that examples 1, 14, 15, 16 and 17 are according to the current invention, where a mixture of starting siloxane is used. In Example 1 the ration of higher and lower viscosity OH-siloxane is same, whereas in Example 14 the ratio of higher viscosity OH-siloxane to lower viscosity OH-siloxane is less than 1, and in Example 15 the ratio of higher viscosity OH-siloxane to lower viscosity OH-siloxane is more than 1. In Example 16 the mixture of OH-siloxane and trialkyl terminated siloxane is used and in example 17 where trimethyl silanol is used as the terminating group along with the mixture of OH-siloxanes along with all the inventive steps as per the current invention.

We find in comparative Example 2 that when the monomodal OH siloxane is used and TEA neutralized anionic emulsifier is used initially to form emulsion where the workability is a major issue and then EP polymerization is performed, though the cyclosiloxane value are at lower range, but PDI is high, and the final emulsion is destabilized. Similarly, for Example 2, that when the monomodal OH siloxane is used and alkali (NaOH) neutralized anionic emulsifier is used initially to form emulsion and then EP polymerization is performed, though the cyclosiloxane value are at lower range, but PDI is high, and the final emulsion is not stabile.

Even if the starting material is started have very low cyclosiloxane concentration as shown in comparative Example 3, 4, 5, 6 having monomodal siloxane as a starting material, and using neutralized Na-dodecylbenzene sulfonate (Ex. 3), using neutralized Na-dodecylbenzene sulfonate with no temperature maintenance during homogenization (Ex 4) or using un-neutralized dodecylbenzene sulfonate (Ex 5), the problem of workability during the process exist, along with deteriorated PDI and stability parameters and also with high cyclosiloxane concentration in the final end product.

Examples 7 and 8 are using bimodal and monomodal OH-siloxane starting polymer respectively, but the homogenization temperature is kept between 35-39° C. and shows separation thus emulsion storage stability is not obtained.

Examples 9 and 10 are using bimodal and monomodal OH-siloxane starting polymer respectively, but the temperature during polymerization is kept 15° C. and we see separation on storage, thus emulsion storage stability is not obtained.

In comparative Example 11 we see that all the parameters are similar to the inventive example except that the polymerization tank temperature is lowered to 3 to 5° C. which took almost 9 hours to drop the temperature from 19° C. to 4° C., and we also found out that the cyclosiloxane levels are higher using this process. Similarly, in comparative Example 12, we find that monomodal OH-siloxane is used and the polymerization tank temperature is lowered to 3 to 5° C. which took almost 9 hours to drop the temperature from 19° C. to 4° C., and we also found out that the cyclosiloxane levels are higher and the final emulsion is not stable.

In comparative Example 13 we again find that the use of monomodal OH-siloxane of viscosity 5000 mPa·s at 25° C. also shows a big problem in circulation and to reach lower temperature at the emulsion tank it takes more time, and the final product has higher cyclosiloxane with no final emulsion stability.

Similarly, we see in comparative Example 18, that though using OH polymer and trimethyl siloxy polydimethyl siloxane mixture but using non-neutralized dodecylbenzene sulfonic acid gives higher cyclosiloxane in the final polymer formed by emulsion polymerization.

Similarly, we see in comparative Example 19, that though using OH polymer 5000 mPa·s and OH polymer 80 mPa·s mixture using neutralized dodecylbenzene sulfonic but the emulsion polymerization temperature of 15-20° C. gives higher cyclosiloxane in the final polymer formed by emulsion polymerization.

Thus, we see from the non-limiting examples that the parameters as used in the current invention are most appropriate to get the desired stable emulsion of higher polymer viscosity having cyclosiloxane concentration in the desired range.

1. A commercial manufacturing process of a stable emulsion having particle size (D50 value) of up to 1000 nanometer and cyclosiloxane content of upto 3000 ppm comprising:
i) providing a formulation comprising
(a) a starting organopolysiloxane comprising two or more organopolysiloxane which is the same or different of general formula (I) or its mixture 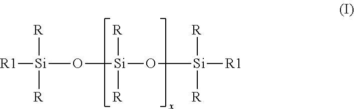
where R¹ is same or different and is a monovalent hydrocarbon group of 1 to 10 carbon atoms or a hydroxyl group or an alkoxy group having 1 to 8 carbon atoms,
R is same or different and is a monovalent hydrocarbon radical,
x is same or different and is an integer from 1 to 2000,
(b) water,
(c) a non-ionic emulsifier(s) having HLB in the range of 8-19 and
(d) a neutralized anionic emulsifier;
ii) homogenizing the formulation using any standard homogenizer and maintaining a temperature up to 35° C.;
iii) cooling the formulation below a temperature of 12° C.;
iv) adding an anionic emulsifier to obtain an organopolysiloxane polymer with viscosity of at least 20000 mPa·s at 25° C.; and
iii) neutralizing the emulsion by alkali to a pH range of 6 to 8.

2. The commercial manufacturing process of claim 1, wherein the anionic emulsifier is an acid selected from alkyl aryl sulfonic acid, alkyl sulfonic acid, aryl sulfonic acid or its mixture thereof.

3. The commercial manufacturing process of claim 1, wherein the neutralized anionic emulsifier is an alkanolamine neutralized salt of organic sulfonic acid selected from alkyl aryl sulfonic acid, alkyl sulfonic acid, aryl sulfonic acid or its mixture thereof.

4. The commercial manufacturing process of claim 1, wherein the neutralized anionic emulsifier is having HLB in the range of 8 to 19.

5. The commercial manufacturing process of claim 1, wherein R1 is a hydroxyl group or an alkoxy group having 1 to 8 carbon atoms.

6. The commercial manufacturing process of claim 1, wherein the starting polyorganosiloxane is a mixture of two or more polyorganosiloxane of general formula I.

7. The commercial manufacturing process of claim 1, wherein the starting organopolysiloxane having a cyclosiloxane content of up to 1000 ppm.

8. The commercial manufacturing process of claim 1, wherein the stable emulsion having cyclosiloxane content of preferably up to 1000 ppm
